(19) United States
(12) Patent Application Publication
(10) Pub. No.: US 2023/0198303 A1
(43) Pub. Date: Jun. 22, 2023

(54) WIRELESS CHARGING ADDITIONAL APPARATUS AND WIRELESS POWER TRANSMITTING AND RECEIVING APPARATUSES

(71) Applicant: NINGBO WEIE ELECTRONICS TECHNOLOGY LTD., Ningbo (CN)

(72) Inventors: Feng Yu, Ningbo (CN); Lulu Song, Ningbo (CN); Lizhi Xu, Ningbo (CN); Weiyi Feng, Ningbo (CN)

(73) Assignee: NINGBO WEIE ELECTRONICS TECHNOLOGY LTD., Ningbo (CN)

(21) Appl. No.: 18/063,452

(22) Filed: Dec. 8, 2022

(30) Foreign Application Priority Data
Dec. 22, 2021 (CN) 202111583133.2

(51) Int. Cl. H02J 50/00; H02J 50/12; H02J 50/40

(52) U.S. Cl. CPC H02J 50/005; H02J 50/12; H02J 50/40

(57) ABSTRACT

The present disclosure discloses a wireless charging additional apparatus and wireless power transmitting and receiving apparatuses, the wireless charging additional apparatus includes a first planar coil, a second planar coil, and a connecting part, the first planar coil and the second planar coil respectively include a plurality of coil turns, and the connecting part connects leading-out ends of the first planar coil and the second planar coil, where the first planar coil, the second planar coil and the connecting part are connected in series, the first planar coil is provided inside the second planar coil, and current directions in the first planar coil and the second planar coil are opposite. Thus, according to the present disclosure, by providing a certain winding mode of a coil, efficiency of wireless charging can be improved, and loss is reduced.

### CLAIM OF PRIORITY AND CROSS-REFERENCE TO RELATED APPLICATION(S)

This application claims the benefit of Chinese Patent Application No. 202111583133.2, filed on Dec. 22, 2021, which is incorporated herein by reference in its entirety.

### BACKGROUND OF THE INVENTION

### 1. Field of the Invention

The embodiment of the present disclosure relates to the field of wireless power, and in particular to, a wireless charging additional apparatus and wireless power transmitting and receiving apparatuses.

### 2. Description of the Related Art

Wireless charging technologies may transmit power between electronic devices in a wireless manner, and therefore, the wireless charging technologies are widely applied to consumer electronic products and other types of electronic products. The wireless charging technologies generally implement wireless transmission of power through mutual electromagnetic coupling of a transmitting end coil and a receiving end coil. The transmitting end converts a direct current voltage into an alternating current, and the alternating current generates an alternating magnetic field through a transmitting end coil. The receiving end is coupled to the alternating magnetic field to induce a corresponding alternating voltage, and the alternating voltage is converted into the direct current voltage through a rectifier circuit to charge an electronic device.

As shown in FIG. 1, in the prior art, in order to improve strength of the magnetic field, a wireless charging additional apparatus may be provided between a wireless power transmitting coil and a wireless power receiving coil, and by connecting the coil in parallel with a plurality of turns, a magnetic field in the same direction as that of the wireless power transmitting coil is generated inside the coil, thereby further improving the coupling between the wireless power receiving coil and the wireless power transmitting coil. However, if the number of parallel turns is increased, in the circled area shown in the figure, the windings connected to the inner ring and the outer ring also need to be increased correspondingly. This area cannot provide an effective magnetic field, and at the same time, the high-frequency alternating current flowing through this area causes additional losses.

### BRIEF DESCRIPTION OF THE INVENTION

In view of this, the embodiment of the present disclosure provides a wireless charging additional apparatus and wireless power transmitting and receiving apparatuses, so that a utilization rate of coil area and charging efficiency can be improved.

In a first aspect, the wireless charging additional apparatus according to an embodiment of the present disclosure includes:
a first planar coil, including a plurality of coil turns;
a second planar coil, including a plurality of coil turns; and
a connecting part, connecting leading-out ends of the first planar coil and the second planar coil,
where the first planar coil, the second planar coil and the connecting part are connected in series, the first planar coil is arranged inside the second planar coil, and current directions in the first planar coil and the second planar coil are opposite.

Optionally, one or more compensation capacitors are connected in series or in parallel in the wireless charging additional apparatus.

Optionally, the first planar coil is concentrically arranged with the second planar coil.

Optionally, the number of turns of the first planar coil is greater than that of the second planar coil.

Optionally, a spacing between the coil turns of the first planar coil is a first spacing, a spacing between the coil turns of the second planar coil is a second spacing, and the first spacing and the second spacing are different.

Optionally, the first spacing is less than the second spacing.

Optionally, the wireless charging additional apparatus further includes a third planar coil, the third planar coil is provided outside of the second planar coil, and current directions of the third planar coil and the second planar coil are the same;
a leading-out end of the third planar coil is respectively connected to the leading-out end of the first planar coil and the leading-out end of the second planar coil through the connecting part; or
the leading-out end of the third planar coil is connected to the leading-out end of the first planar coil through the connecting part.

Optionally, the wireless charging additional apparatus further includes a first magnetic sheet, the first magnetic sheet has a hollowed-out area, and the size of the hollowed-out area is greater than that of the first planar coil.

Optionally, the wireless charging additional apparatus further includes a second magnetic sheet, the second magnetic sheet is arranged on another side of the wireless charging additional apparatus other than a side on which a first magnetic sheet is arranged, and the second magnetic sheet has a size matching the first planar coil.

Optionally, the compensation capacitor is arranged at a position other than the first magnetic sheet and the second magnetic sheet.

Optionally, the wireless charging additional apparatus is arranged on a circuit board, the circuit board has a via hole, and the first planar coil, the second planar coil, and the connecting part are arranged on both sides of the circuit board through the via hole.

Optionally, the wireless charging additional apparatus includes a housing, the wireless charging additional apparatus is provided inside the housing.

In a second aspect, the wireless power transmitting apparatus according to an embodiment of the present disclosure includes:
a wireless power transmitting coil; and
the wireless charging additional apparatus, arranged on one side of the wireless power transmitting coil facing a corresponding wireless power receiving coil, and spaced apart from the wireless power transmitting coil by a predetermined distance.

In a third aspect, the wireless power receiving apparatus according to an embodiment of the present disclosure includes:
a wireless power receiving coil; and
the wireless charging additional apparatus, arranged on one side of the wireless power receiving coil facing a corresponding wireless power transmitting coil, and spaced apart from the wireless power receiving coil by a predetermined distance.

The wireless charging additional apparatus according to an embodiment of the disclosure includes a first planar coil, a second planar coil, and a connecting part, the first planar coil and the second planar coil respectively include a plurality of coil turns, and the connecting part connects leading-out ends of the first planar coil and the second planar coil, where the first planar coil, the second planar coil and the connecting part are connected in series, the first planar coil is provided inside the second planar coil, and current directions in the first planar coil and the second planar coil are opposite. The wireless power transmitting apparatus and the wireless power receiving apparatus are provided with the wireless charging additional apparatus. Thus, according to the technical solutions of the embodiment of the present disclosure, by providing a winding mode of a coil, efficiency of wireless charging can be improved, and loss can be reduced.

### BRIEF DESCRIPTION OF THE DRAWINGS

FIG. 1 is a schematic structural diagram of a wireless charging additional apparatus in the prior art;

FIG. 2 is a schematic diagram of a first embodiment of a wireless charging additional apparatus according to an embodiment of the present disclosure;

FIG. 3 is a schematic diagram of a second embodiment of a wireless charging additional apparatus according to an embodiment of the present disclosure;

FIG. 4 is a schematic diagram of a third embodiment of a wireless charging additional apparatus according to an embodiment of the present disclosure;

FIG. 5 is a schematic diagram of a fourth embodiment of a wireless charging additional apparatus according to an embodiment of the present disclosure;

FIG. 6 is a schematic diagram of a fifth embodiment of a wireless charging additional apparatus according to an embodiment of the present disclosure;

FIG. 7 is a schematic comparative diagram of a sixth embodiment and a seventh embodiment of a wireless charging additional apparatus according to an embodiment of the present disclosure;

FIG. 8 is a schematic diagram of an eighth embodiment of a wireless charging additional apparatus according to an embodiment of the present disclosure;

FIG. 9 is a schematic diagram of a ninth embodiment of a wireless charging additional apparatus according to an embodiment of the present disclosure; and

FIG. 10 is a schematic diagram of a wireless charging additional apparatus arranged on a circuit board according to an embodiment of the present disclosure.

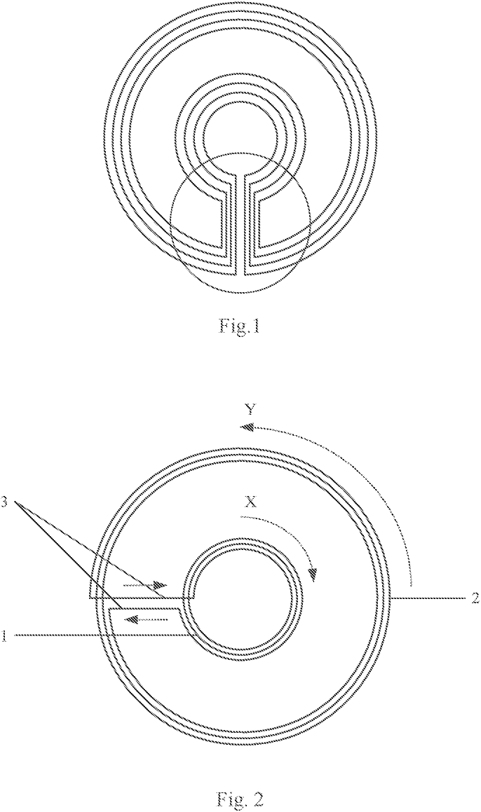

### BRIEF DESCRIPTION OF REFERENCE NUMERALS OF THE DRAWINGS

1-first planar coil; 2-second planar coil; 3-connecting part; 4-third planar coil; 51-first magnetic sheet; 52-second magnetic sheet; 6-circuit board; 61-via hole; Cr-compensation capacitor; X-first direction; and Y-second direction.

### DETAILED DESCRIPTION OF EMBODIMENTS OF THE INVENTION

The present disclosure is described below based on embodiments, but the present disclosure is not merely limited to these embodiments. In the following detailed description of the present disclosure, some specific details are described in detail. Those skilled in the art may fully understand the present disclosure without the description of these details. In order to avoid obscuring the essence of the present disclosure, well-known methods, processes, procedures, elements and circuits are not described in detail.

In addition, those of ordinary skill in the art should be understood that drawings provided herein are for illustrative purposes, and the drawings are not necessarily drawn to scale.

Unless the context clearly requires otherwise, similar words such as “including” and “containing” throughout the application document should be interpreted as inclusive rather than exclusive or exhaustive; that is to say, it means “including but not limited to”.

In the description of the disclosure, it should be understood that the terms “first” and “second” are only used for descriptive purposes, and cannot be understood as indicating or implying relative importance. In addition, in the description of the disclosure, unless otherwise stated, “plurality” means two or more.

Unless otherwise clearly specified and limited, the terms “installed”, “connected”, “connection”, “fixed”, etc. should be understood broadly. For example, the “connection” may be a fixed connection, a detachable connection, or an integrated connection, may be a mechanical connection or an electrical connection, may be a direct connection or an indirect connection by means of an intermediate medium, or may be an internal connection of two elements or an interaction between two elements, unless otherwise clearly defined. For those of ordinary skill in the art, the specific meaning of the terms in the present disclosure may be understood according to specific situations.

The technical scheme of the disclosure is further explained by the specific embodiments in conjunction with the drawings.

FIG. 2 is a schematic diagram of a first embodiment of a wireless charging additional apparatus according to an embodiment of the present disclosure. As shown in FIG. 2, the wireless charging additional apparatus includes a first planar coil 1, a second planar coil 2, and a connecting part 3. The first planar coil 1 and the second planar coil 2 respectively include a plurality of coil turns, and the connecting part 3 connects leading-out ends of the first planar coil 1 and the second planar coil 2, where the first planar coil 1, the second planar coil 2 and the connecting part 3 are connected in series, the first planar coil 1 is provided inside the second planar coil 2, and current directions in the first planar coil 1 and the second planar coil 2 are opposite. In other words, the first planar coil 1 and the second planar coil 2 are formed as two coil groups independent of each other, and the connecting part 3 connects lead ends of the two to each other, so as to form a closed loop, so that current flows through the first planar coil 1 and the second planar coil 2 in different directions.

Further, the first planar coil 1 is concentrically arranged with the second planar coil 2. According to the law of electromagnetic induction, when a magnetic field passes through a closed coil, an induced electromotive force is generated inside the coil, thereby further generating a corresponding induced magnetic field based on a winding direction of the coil. In this embodiment, the first planar coil 1 and the second planar coil 2 are wound in opposite directions, and the connecting part 3 is respectively connected to an outer lead end of the first planar coil 1 and an inner lead end of the second planar coil 2, and an inner lead end of the first planar coil 1 and an outer lead end of the second planar coil 2, so that current flows through the first planar coil 1 in a first direction X, and through the second planar coil 2 in a second direction Y, where the first direction X is opposite to the second direction Y. Therefore, when an external magnetic field passes through the wireless charging additional apparatus, an induced magnetic field corresponding to the direction of the internal induced current in the first planar coil 1 and the second planar coil 2 is generated in the first planar coil 1 and the second planar coil 2. In other words, during the use of the wireless charging additional apparatus, the wireless charging additional apparatus is placed between the wireless power transmitting coil and the wireless power receiving coil, so that the position of the first planar coil 1 corresponds to the position of the wireless power receiving coil, and the magnetic field directed by the wireless power transmitting coil to the wireless power receiving coil passes therethrough, so that an induced magnetic field in the same or opposite direction as the magnetic field is generated in the first planar coil 1 and the second planar coil 2.

At this time, if the induced magnetic field generated in the first planar coil 1 is made to be in the same direction as the magnetic field transmitted by the wireless power transmitting coil, the magnetic field received by the wireless power receiving coil can be enhanced, and the receiving efficiency of the wireless power receiving coil can be improved. In addition, at a part between the first planar coil 1 and the second planar coil 2, an induced magnetic field opposite to the magnetic field transmitted by the wireless power transmitting coil is generated, so that eddy current loss, generated by the magnetic field which is transmitted by the wireless power transmitting coil and acts on other metal materials, is reduced, thereby further improving the transmission efficiency of wireless power.

The size of the first planar coil 1 should be matched with the size of the wireless power receiving coil, that is to say, the first planar coil 1 should have a size similar to that of the wireless power receiving coil, so that the wireless power receiving coil may have a better coupling degree when the induced magnetic field in the same direction of a wireless power magnetic field is generated.

Optionally, the first planar coil 1 and the second planar coil 2 may also be wound in the same direction, at this time, the connecting part 3 is respectively connected to an inner lead end of the first planar coil 1 and an inner lead end of the second planar coil 2, and an outer lead end of the first planar coil 1 and an outer lead end of the second planar coil 2.

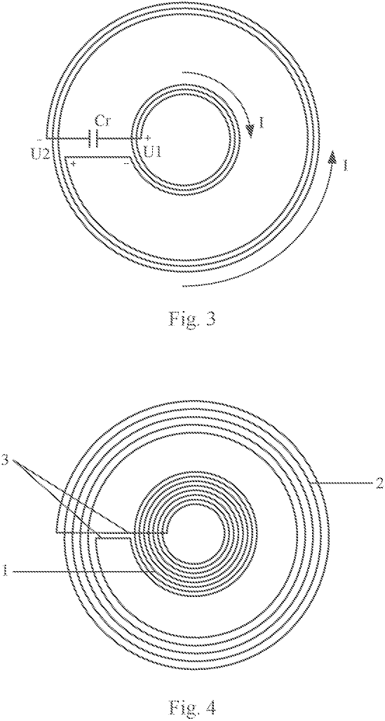

FIG. 3 is a schematic diagram of a second embodiment of a wireless charging additional apparatus according to an embodiment of the present disclosure. As shown in FIG. 3, one or more compensation capacitors Cr are connected in series or in parallel in the wireless charging additional apparatus.

For ease of description, when the magnetic field directed by the wireless power transmitting coil to the wireless power receiving coil passes therethrough, the induced voltage generated in the first planar coil 1 is set as U1, the induced voltage generated in the second planar coil 2 is set as U2, and then the induced current generated in the coil may be obtained:

$$\text{I =} \frac{\text{U2} - \text{U1}}{\text{j} \text{ω} \text{L} + \text{R}}$$

where L is coil inductive reactance, and R is coil impedance.

In order to further improve the transmission efficiency of the wireless power, increasing the induced magnetic field generated in the first planar coil 1 to increase the number of turns of the first planar coil 1 may be a feasible method. At this time, the induced voltage U1 increases, but the induced current I decreases. At the same time, if the number of turns of the second planar coil 2 is increased, although the difference between the induced voltages U2 and U1 may be increased, the increased impedance R still causes the induced current I to be constant or decreased. Therefore, in this embodiment, the induced current I generated in the coil may be obtained by connecting the compensation capacitor Cr in series in the formed loop:

$$\text{I =} \frac{\text{U2} - \text{U1}}{\text{j} \text{ω} \text{L} + \frac{1}{\text{j} \text{ω} \text{C}} + \text{R}}$$

If

$$\text{j} \text{ω} \text{L} + \frac{1}{\text{j} \text{ω} \text{C}} = 0 ,$$

the induced current is maximized, which maximizes the induced magnetic field provided in the first planar coil 1. In other words, the compensation capacitor Cr may play a role in increasing the induced magnetic field in the circuit. In this embodiment, the compensation capacitor Cr is connected in series to the connecting part 3, and optionally, the compensation capacitor Cr may also be arranged at any position of the coil.

Further, the compensation capacitor Cr may be connected in series by using a plurality of capacitors to reduce an instantaneous voltage borne by a single capacitor, or connected in parallel by using a plurality of capacitors with small capacitance values to reduce a loss of the capacitor, or connected in parallel by using a plurality of capacitors, which is not limited in the present application.

FIG. 4 is a schematic diagram of a third embodiment of a wireless charging additional apparatus according to an embodiment of the present disclosure. As shown in FIG. 4, in order to enable the first planar coil 1 to provide more induced magnetic fields in the same direction as the magnetic field transmitted by the wireless power transmitting coil, and increase the coupling degree of the wireless power receiving coil, the number of turns of the first planar coil 1 should be greater than that of the second planar coil 2. For example, in this embodiment, the number of turns of the first planar coil 1 and the second planar coil 2 is changed, the number of turns of the first planar coil 1 is eight, and the number of turns of the second planar coil 2 is five. Optionally, other numbers of turns may also be set.

Further, a spacing between the coil turns of the first planar coil 1 is a first spacing, a spacing between the coil turns of the second planar coil 2 is a second spacing, and the first spacing and the second spacing are different. In other words, the coil turns of the first planar coil 1 may be wound in a different manner from that of the coil turns of the second planar coil 2, so that the relationship between the induced current U of the coil and the impedance R inside the coil is changed, and the induced current I is further changed. In this embodiment, the first spacing is less than the second spacing, that is, the first planar coil 1 is wound tightly, and the second planar coil 2 is wound loosely. In this case, although the induced voltage U1 of the first planar coil 1 is increased and the induced voltage U2 of the second planar coil 2 is decreased, the impedance R inside the coil may be reduced, thereby increasing the induced current I, so that a stronger induced magnetic field may be generated in the first planar coil 1.

Further, the first spacings of the coil turns of the first planar coil 1 may also be different from each other, and the second spacings of the coil turns of the second planar coil 2 may also be different from each other, which is not limited in the present application.

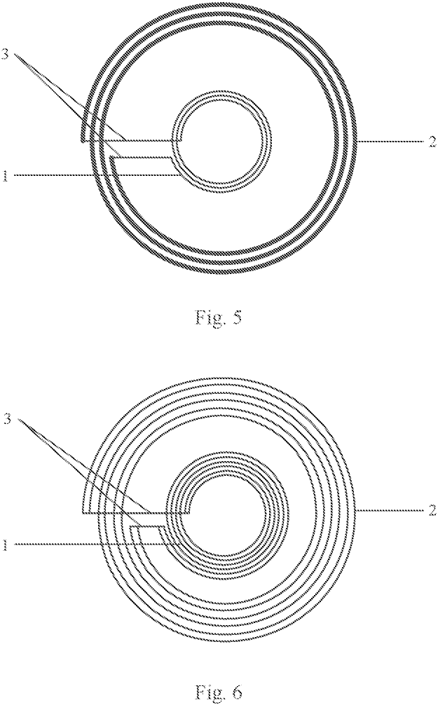

FIG. 5 is a schematic diagram of a fourth embodiment of a wireless charging additional apparatus according to an embodiment of the present disclosure. FIG. 6 is a schematic diagram of a fifth embodiment of a wireless charging additional apparatus according to an embodiment of the present disclosure. As shown in FIGS. 5 and 6, the coil turns of the first planar coil 1 and the second planar coil 2 may further have other arrangements.

In the fourth embodiment, the second planar coil 2 is wound by using a wire having a relatively large diameter. In the fifth embodiment, the first planar coil 1 and the second planar coil 2 are wound in parallel with two strands. In other words, the internal impedance R of the coil may be further reduced by increasing the diameter of the wire or connecting a plurality of wires in parallel, thereby increasing the induced current I, so that the first planar coil 1 may provide a stronger induced magnetic field, and the transmission efficiency of wireless power may be improved.

In the third embodiment, the fourth embodiment, and the fifth embodiment, changing the winding spacing, changing the wire diameter, and increasing the parallel wires are respectively adopted to reduce the impedance R of the coil, so that the induced current I inside the coil is increased. Optionally, the wireless charging additional apparatus may also reduce the impedance R in other ways, so as to improve the induced magnetic field in the first planar coil 1.

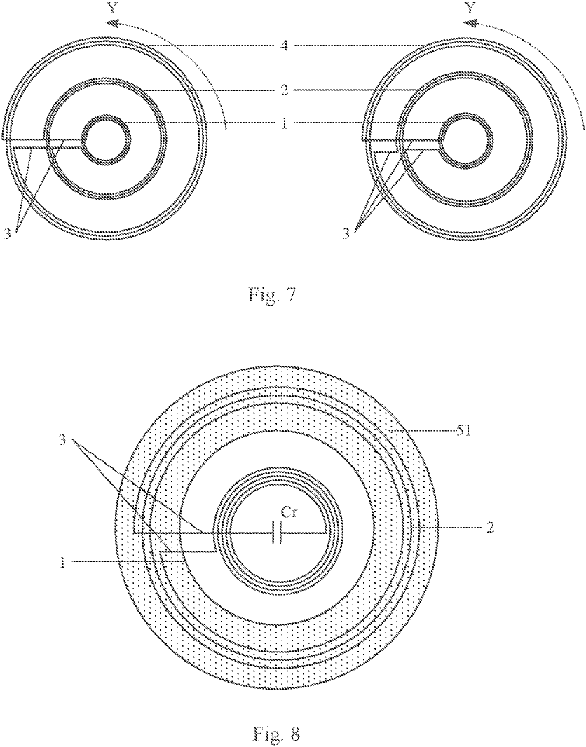

FIG. 7 is a schematic comparative diagram of a sixth embodiment and a seventh embodiment of a wireless charging additional apparatus according to an embodiment of the present disclosure. As shown in FIG. 7, the wireless charging additional apparatus further includes a third planar coil 4, and the third planar coil 4 is arranged outside of the second planar coil 2. In other words, the third planar coil 4 has the same current direction as that of the second planar coil 2, and the induced current I flows through the third planar coil 4 along the second direction Y. A leading-out end of the third planar coil 4 is respectively connected to the leading-out end of the first planar coil 1 and the leading-out end of the second planar coil 2 through the connection part 3, or is connected to the leading-out end of the first planar coil 1 through the connecting part 3. In other words, the third planar coil 4 may be connected in series or in parallel to the second planar coil 2. In the case of series connection, the third planar coil 4 may provide a larger induced voltage U2; and in the case of parallel connection, the third planar coil 4 may reduce the impedance R of the coil, thereby improving the induced current I.

In the sixth embodiment and the seventh embodiment, the third planar coil 4 is formed as a three-turn coil having the same winding direction as that of the second planar coil 2 outside and the second planar coil 2. Further, the spacing between the coil turns of the third planar coil 4 may be a third spacing, the third spacing may be equal to or greater than the second spacing, and as for the same reason as the second spacing, the third spacing should be greater than the first spacing. In other words, the relationship among the three should be that the first spacing is less than the second spacing, and the second spacing is less than or equal to the third spacing. In addition, the third spacings of the coil turns of the third planar coil 4 may be different from each other.

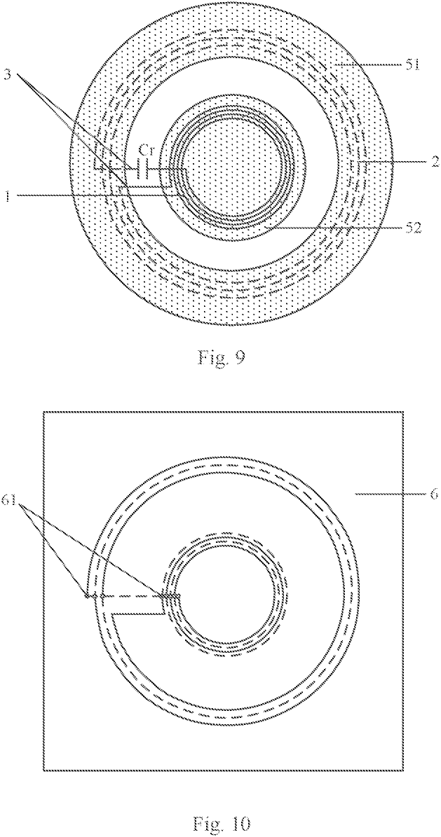

FIG. 8 is a schematic diagram of an eighth embodiment of a wireless charging additional apparatus according to an embodiment of the present disclosure. FIG. 9 is a schematic diagram of a ninth embodiment of a wireless charging additional apparatus according to an embodiment of the present disclosure As shown in FIGS. 8 and 9, the wireless charging additional apparatus further includes a magnetic sheet.

In the eighth embodiment, the wireless charging additional apparatus includes a first magnetic sheet 51, the first magnetic sheet 51 has a hollowed-out area, and the size of the hollowed-out area is greater than that of the first planar coil 1. In other words, the first magnetic sheet 51 is covered on the second planar coil 2 and is configured to increase the induced voltage U2 of the second planar coil 2, thereby improving the induced current I, so that a stronger induced magnetic field is generated in the first planar coil 1, and unnecessary interference is further shielded. In this embodiment, the hollowed-out area is formed in a circular shape matching the first planar coil 1, and optionally, the hollowed-out area may also be designed in other shapes, such as an ellipse.

In the ninth embodiment, the wireless charging additional apparatus further includes a second magnetic sheet 52 in addition to the first magnetic sheet 51, and the second magnetic sheet 52 is arranged below the first planar coil 1 and has a size matching the first planar coil 1. In other words, the second planar coil 2 generates the induced voltage U2 in response to the magnetic field directed from the wireless power transmitting coil to the wireless power receiving coil, the first magnetic sheet 51 covered thereon has the effect of increasing the induced voltage U2, and the corresponding induced current I further flows through the first planar coil 1, so that the induced voltage U1 is also generated in the first planar coil 1, and the second magnetic sheet 52 below the first planar coil 1 has the effect of increasing the induced voltage U1, so that the induced magnetic field in the first planar coil 1 is enhanced. Therefore, the second magnetic sheet 52 below the first planar coil 1 enables the wireless charging additional apparatus to better couple the wireless power receiving coil, and the first magnetic sheet 51 covered on the second planar coil 2 enables the wireless charging additional apparatus to better couple the wireless power transmitting coil.

Optionally, materials of the first magnetic sheet 51 and the second magnetic sheet 52 may be common soft magnetic materials, such as a nickel-zinc ferrite magnetic sheet, a manganese-zinc ferrite magnetic sheet, or amorphous and nano-crystalline.

Further, in order to prevent the magnetic sheets from affecting property of the compensation capacitors Cr, when the compensation capacitor Cr is provided in the wireless charging additional apparatus, the compensation capacitor Cr should be provided at a position other than the first magnetic sheet 51 and the second magnetic sheet 52. In other words, the compensation capacitor Cr should be provided in a hollowed-out area of the coil that does not pass through the first magnetic sheet 51 and the second magnetic sheet 52, or a partial hollowed-out may be provided at other positions of the first magnetic sheet 51 and the second magnetic sheet 52 to place the compensation capacitor Cr. This design may reduce thickness of the wireless charging additional apparatus, so that a product is smaller in volume and has better usability.

In the sixth embodiment, the seventh embodiment, the eighth embodiment, and the ninth embodiment, adding the third planar coil 4 connected in series or in parallel and adding magnetic sheets are respectively adopted to improve the induced voltage U2 of the second planar coil 2, so that the induced current I inside the coil is increased. Optionally, the wireless charging additional apparatus may also increase the induced voltage U2 in other ways, so as to improve the induced magnetic field in the first planar coil 1.

FIG. 9 is a schematic diagram of a wireless charging additional apparatus arranged on a circuit board according to an embodiment of the present disclosure. As shown in FIG. 9, the wireless charging additional apparatus may be wound by using a wire such as a cooper wire or a Litz wire to form a coil, or may be arranged on the circuit board 6. In the case where the circuit board 6 has a via hole 61, the first planar coil 1, the second planar coil 2, and the connecting part 3 may be arranged on both sides of the circuit board 6 through the via hole 61. In other words, in the winding process of the coil, a communication loop may be formed between the front side and the back side of the circuit board 6 though the via hole 61 once or more times, so that the first planar coil 1 and the second planar coil 2 are formed together on the front side and the back side of the circuit board 6. Optionally, the via hole 61 may have an arrangement different from that of the embodiment.

Further, the wireless charging additional apparatus further includes a housing, and the wireless charging additional apparatus is provided inside the housing. In this embodiment, the housing is a mobile phone case. In other words, in an actual application scenario, the wireless charging additional apparatus is arranged inside the mobile phone case. However, in the case where a mobile phone case is mounted on a mobile phone, when the mobile phone is matched with the external wireless power transmitting coil for wireless charging, the wireless charging additional apparatus is located between the wireless power transmitting coil and the wireless power receiving coil in the mobile phone, so that the effect of increasing the coupling degree of the wireless power receiving coil of the mobile phone and improving the charging efficiency may be implemented. This design enables the wireless charging additional apparatus to have good usability, and is convenient to carry and use. Optionally, the housing may also be a protective housing for other products with a wireless power transmitting coil arranged inside.

Further, the wireless charging additional apparatus may be used as a product alone, or may be configured to be used as an element in other wireless power devices to improve the transmission efficiency of wireless power. For example, the wireless charging additional apparatus may be applied to a wireless power transmitting apparatus including a wireless power transmitting coil, and the wireless charging additional apparatus is arranged on one side of the wireless power transmitting coil facing a corresponding wireless power receiving coil, and is spaced apart from the wireless power transmitting coil by a predetermined distance. Alternatively, the wireless charging additional apparatus is provided in a wireless power receiving apparatus including a wireless power receiving coil, and the wireless charging additional apparatus is arranged on one side of the wireless power receiving coil facing a corresponding wireless power transmitting coil, and is spaced apart from the wireless power receiving coil by a predetermined distance. Or in other wireless power systems, which is not limited herein.

The wireless charging additional apparatus according to an embodiment of the disclosure includes a first planar coil, a second planar coil, and a connecting part, the first planar coil and the second planar coil respectively include a plurality of coil turns, and the connecting part connects leading-out ends of the first planar coil and the second planar coil, where the first planar coil, the second planar coil and the connecting part are connected in series, the first planar coil is provided inside the second planar coil, and current directions in the first planar coil and the second planar coil are opposite. The wireless power transmitting apparatus and the wireless power receiving apparatus are provided with the wireless charging additional apparatus. Thus, according to the technical solutions of the embodiment of the present disclosure, by providing a winding mode of a coil, efficiency of wireless charging may be improved, and loss is reduced.

The above description is merely preferred embodiments of the present disclosure and is not used to limit the present disclosure. For those skilled in the art, the present disclosure may have various modifications and variations. Any modification, equivalent replacement, improvement, and the like made with the spirit and principle of the present disclosure should be included in the protection scope of the present disclosure.

We claim:

1. A wireless charging additional apparatus, comprising:
a first planar coil, comprising a plurality of coil turns;
a second planar coil, comprising a plurality of coil turns; and
a connecting part, connecting leading-out ends of the first planar coil and the second planar coil,
wherein the first planar coil, the second planar coil and the connecting part are connected in series, the first planar coil is provided inside the second planar coil, and current directions in the first planar coil and the second planar coil are opposite.

2. The wireless charging additional apparatus of claim 1, wherein one or more compensation capacitors are connected in series or in parallel in the wireless charging additional apparatus.

3. The wireless charging additional apparatus of claim 1, wherein the first planar coil is concentrically arranged with the second planar coil.

4. The wireless charging additional apparatus of claim 1, wherein the number of turns of the first planar coil is greater than that of the second planar coil.

5. The wireless charging additional apparatus of claim 1, wherein a first spacing between the coil turns of the first planar coil is different from a second spacing between the coil turns of the second planar coil.

6. The wireless charging additional apparatus of claim 5, wherein the first spacing is less than the second spacing.

7. The wireless charging additional apparatus of claim 1, wherein the wireless charging additional apparatus further comprises a third planar coil, the third planar coil is provided outside of the second planar coil, and current directions of the third planar coil and the second planar coil are the same;
a leading-out end of the third planar coil is respectively connected to the leading-out end of the first planar coil and the leading-out end of the second planar coil through the connecting part; or
the leading-out end of the third planar coil is connected to the leading-out end of the first planar coil through the connecting part.

8. The wireless charging additional apparatus of claim 2, wherein the wireless charging additional apparatus further comprises a first magnetic sheet, the first magnetic sheet has a hollowed-out area, and the size of the hollowed-out area is greater than that of the first planar coil.

9. The wireless charging additional apparatus of claim 8, wherein the wireless charging additional apparatus further comprises a second magnetic sheet, the second magnetic sheet is arranged on another side of the wireless charging additional apparatus other than a side on which a first magnetic sheet is arranged, and the second magnetic sheet has a size matching the first planar coil.

10. The wireless charging additional apparatus of claim 9, wherein the compensation capacitor is arranged at a position other than the first magnetic sheet and the second magnetic sheet.

11. The wireless charging additional apparatus of claim 1, wherein the wireless charging additional apparatus is arranged on a circuit board, the circuit board has a via hole, and the first planar coil, the second planar coil, and the connecting part are arranged on both sides of the circuit board through the via hole.

12. The wireless charging additional apparatus of claim 1, wherein the wireless charging additional apparatus further comprises a housing, and the wireless charging additional apparatus is provided inside the housing.

13. A wireless power transmitting apparatus, comprising:
a wireless power transmitting coil; and
the wireless charging additional apparatus according to claim 1, wherein the wireless charging additional apparatus is arranged on one side of the wireless power transmitting coil facing a corresponding wireless power receiving coil, and is spaced apart from the wireless power transmitting coil by a predetermined distance.

14. A wireless power receiving apparatus, comprising:
a wireless power receiving coil; and
the wireless charging additional apparatus according to claim 1, wherein the wireless charging additional apparatus is arranged on one side of the wireless power receiving coil facing a corresponding wireless power transmitting coil, and is spaced apart from the wireless power receiving coil by a predetermined distance.
